(19) United States
(12) Patent Application Publication
(10) Pub. No.: US 2002/0049732 A1
(43) Pub. Date: Apr. 25, 2002

(54) Receiving control device, medium and information aggregate

(76) Inventors: Kouichi Matsumura, Osaka (JP); Masaki Saga, Osaka (JP); Tomoaki Watahiki, Osaka (JP); Hideaki Takechi, Osaka (JP); Hajime Maekawa, Osaka (JP); Naonori Kato, Osaka (JP); Mutsuko Yamamoto, Osaka (JP); Masao Ikezaki, Osaka (JP)

Correspondence Address: RATNER AND PRESTIA, Suite 301, One Westlakes, Berwyn, P.O. Box 980, Valley Forge, PA, 19482-0980, US

(21) Appl. No.: 09/871,061

(22) Filed: May 31, 2001

(30) Foreign Application Priority Data
May 31, 2000 (JP) 2000-163,811

(51) Int. Cl. G06F 7/00

(52) U.S. Cl. 707/1

(57) ABSTRACT

A receiving control device has

keyword input means of inputting a keyword,

retrieval means of obtaining program information of a program relating to the input keyword,

user channel matching means of matching the obtained program information with a predetermined user channel number,

direction input means of receiving directions from a user, and

control means of controlling a video receiver,

Wherein

when a direction is received from the direction input means, the control means obtains the broadcast channel number of a program being broadcast at present on the predetermined user channel number and informs the video receiver of the broadcast channel number.

### BACKGROUND OF THE INVENTION

1. Field of the Invention

The present invention relates to a receiving control device, a medium and an information aggregate for controlling AV devices for outputting or recording programs to be broadcast.

2. Related Art of the Invention

FIG. 7 is an example of the configuration of a system for retrieving program information by using a conventional receiving control device.

Referring to FIG. 7, a program information server 71, a receiving control device 72 and a program retrieval device 73 are connected to a network 701. Program information comprising broadcast channel, start time, end time, program title, performer information, etc. is stored in the program information storage section 711 of the program information server 71.

The receiving control device 72 comprises at least a remote controller receiving section 721 and a video receiver control section 722. The remote controller receiving section 721 receives remote controller signals transmitted from a remote controller operated by a user. AV/C commands and the like for receiving a channel signal designated by the user are created by the video receiver control section 722 and used to control a receiver connected to the network 701.

The program retrieval device 73 comprises a keyword input section 731 and a retrieval section 732. The user inputs a keyword by using the keyword input section 731. By using the designated keyword, the program retrieval device 73 retrieves information stored in the program information storage section 711 of the program information server 71 and obtains program information

In the case when program information is offered to the user by using devices including the above-mentioned conventional receiving control device 72, the program information is placed on a server installed by a broadcast station. Hence, the program information is offered in channel units preset by the broadcast station. Therefore, information desired by each user is not always offered on a single channel, but is frequently present over a plurality of channels.

For example, when a user wishes to watch only the program in which a specific person appears, it is necessary that the user retrieves the program in which the specific person appears from the program information and that the user himself or herself operates a channel selector at the time when the program starts in order to watch the program.

Furthermore, since broadcasts are offered via various means, such as ground waves, satellite broadcasting, cable television and distribution through Internet, program information offering means, such as EPG, have been contrived. However, since the number of channels is enormous, it has become difficult for the user to find desired programs even if the EPG or the like is used.

Furthermore, if channels are prepared for each user and if the user himself or herself can draw up a program table, it is possible to offer meticulous service to each user. However, broadcasting programs suited for the preferences of each user is very burdensome to broadcast stations because of high cost. In addition, it is also difficult for the user himself or herself to have dedicated broadcast channels because of high cost for maintenance, management, etc.

In other words, in the system including the conventional receiving control device, it is difficult to find out programs suited for the preferences of the user, thereby causing a problem (a first problem).

Furthermore, in the system including the conventional receiving control device, it is difficult to broadcast programs suited for the preferences of each user by using channels dedicated to the user because of high cost on the sides of the user and/or broadcast stations, thereby causing another problem (a second problem).

### SUMMARY OF THE INVENTION

In consideration of the above-mentioned first problem, the present invention is intended to provide a receiving control device, a medium and an information aggregate, capable of facilitating the finding of programs suited for the preferences of each user.

In consideration of the above-mentioned second problem, the present invention is intended to provide a receiving control device, a medium and an information aggregate, capable of offering programs suited for the preferences of each user at low cost as if problems are broadcast by using dedicated channels.

The 1st invention of the present invention is a receiving control device comprising:

keyword input means of inputting a keyword,

retrieval means of obtaining program information of a program relating to said input keyword,

user channel matching means of matching said obtained program information with a predetermined user channel number,

direction input means of receiving directions from a user, and

control means of controlling a video receiver,

Wherein

when a direction is received from said direction input means, said control means obtains the broadcast channel number of a program being broadcast at present on said predetermined user channel number and informs said video receiver of said broadcast channel number.

The 2nd invention of the present invention is a receiving control device comprising:

keyword input means of inputting a keyword,

retrieval means of obtaining program information of a program relating to said input keyword,

user channel matching means of matching said keyword with a predetermined user channel number,

direction input means of receiving directions from a user, and

control means of controlling a video receiver,

Wherein

when a direction is received from said direction input means, said retrieval means obtains program information of a program relating to said keyword matched with said predetermined user channel number, and

said control means obtains the broadcast channel number of a program being broadcast at present from said obtained program information and informs said video receiver of said broadcast channel number.

The 3rd invention of the present invention is a receiving control device in accordance with 1st or 2nd inventions, wherein said obtained program information includes at least broadcast channel number, broadcast start time and broadcast end time.

The 4th invention of the present invention is a receiving control device in accordance with any one of 1st to 3rd inventions, wherein said retrieval means retrieves program information to obtain a program relating to said keyword.

The 5th invention of the present invention is a receiving control device in accordance with any one of 1st to 3rd inventions, wherein

said retrieval means transmits said keyword input via a network to a program information server connected to said network,

said program information server stores program information, and retrieves program information of a program relating to said keyword from said stored program information by using said transmitted keyword, and

said retrieval means obtains said program information retrieved by said program information server.

The 6th invention of the present invention is a receiving control device in accordance with 5th invention, further comprising video recording medium control means of operating a recording medium for recording video information, wherein

when programs matched with said predetermined user channel number are broadcast on plural broadcast channels, said video recording medium control means records programs other than at least either one of the programs on said video recording medium, and

when a direction is received from said direction input means in a time period during which there is no program matched with said predetermined user channel number, said video recording medium control means reproduces said programs recorded on said video recording media.

The 7th invention of the present invention is a receiving control device in accordance with 5th or 6th inventions, wherein said keyword input means inputs said keywords from a keyword server connected to said network and used to transmit said keywords.

The 8th invention of the present invention is a receiving control device in accordance with 7th invention,

Wherein

inputting said keywords means that plural keywords are obtained from said keyword server, and

said keywords to be input are those selected from among said plural keywords.

The 9th invention of the present invention is a receiving control device in accordance with any one of 5th to 8th inventions, further comprising program information change monitoring means for carrying out monitoring as to whether program information stored in said program information server is renewed or not, wherein

when said program information change monitoring means detects that the program information stored in said program information server is renewed after the time when said retrieval means last obtained program information of a program relating to said keyword,

said retrieval means renews said obtained program information on the basis of the result of said detection.

The 10th invention of the present invention is a receiving control device in accordance with 9th invention, wherein said detection is carried out by making inquiries to said program information server at predetermined time intervals as to the renewal time of said program information stored in said program information server.

The 11th invention of the present invention is a receiving control device in accordance with any one of 5th to 10th inventions, further comprising an area information holding means of holding area information for specifying an area wherein said receiving control device itself is installed, wherein

when transmitting said input keywords to said program information server, said retrieval means also transmits said area information to said program information server, and

said program information server carries out retrieval in consideration of said transmitted area information.

The 12th invention of the present invention is a receiving control device in accordance with any one of 1st to 11th inventions, further comprising a program information display means of displaying program information,

Wherein

said program information display means displays said program information in a table format including at least said keywords or said remote controller channel numbers corresponding to said keywords, time information, program titles,

one of the ordinate and the abscissa of said format represents said keywords or said remote controller channel numbers corresponding to said keywords, and the other represents time information.

The 13th invention of the present invention is a receiving control device in accordance with 7th or 8th inventions, wherein said program information server has the function of said keyword server.

The 14th invention of the present invention is a medium having programs and/or data for activating all or part of functions of all or part of means of said receiving control device in accordance with any one of 1st to 13th inventions on a computer, wherein said medium can be processed by a computer.

The 15th invention of the present invention is an information aggregate characterized by programs and/or data for activating all or part of functions of all or part of means of said receiving control device in accordance with any one of 1st to 13th inventions on a computer.

In the present invention, a user designates a keyword characterizing a program he or she wishes to watch. By using the keyword, retrieval is carried out from program information stored in a server on a network to obtain program information comprising the broadcast channel, start time and end time of a program matched with the keyword. The program obtained by this retrieval may be present on a different broadcast channel. When the keyword designated by the user is assigned to a channel of the remote controller operated by the user and when the user selects the channel, the obtained program information is retrieved. If there is a program matched with the keyword and being broadcast at present, the channel of the broadcast is set automatically. This can apparently be seen as if the user has his or her dedicated broadcast channels.

### BRIEF DESCRIPTION OF THE DRAWINGS

FIG. 1 is a block diagram showing a receiving control device in accordance with a first embodiment of the present invention;

FIG. 2 is a block diagram showing a receiving control device in accordance with a second embodiment of the present invention;

FIG. 3 is a block diagram showing a receiving control device in accordance with a third embodiment of the present invention;

FIG. 4 is a block diagram showing a receiving control device in accordance with a fourth embodiment of the present invention;

FIG. 5 is a block diagram showing a receiving control device in accordance with a fifth embodiment of the present invention;

FIG. 6 is a block diagram showing a receiving control device in accordance with a sixth embodiment of the present invention;

FIG. 7 is a block diagram showing the conventional receiving control device; and

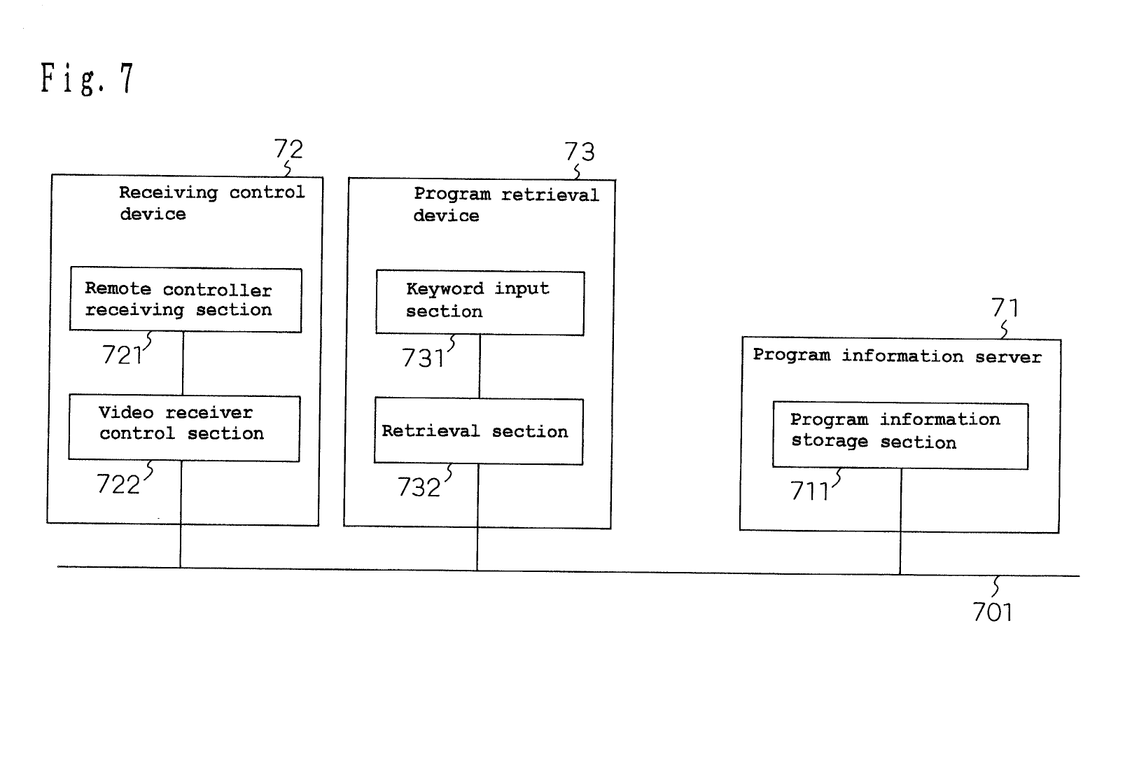

FIG. 8 is a view showing an example of a virtual channel display format based on GUI in accordance with the sixth embodiment of the present invention.

### Description of the Numerals

1, 2, 3, 4, 5, 6 receiving control device

101, 201, 301, 401, 501, 601 network

102, 202, 302, 402, 502, 602 keyword input section

103, 203, 303, 403, 503, 603 retrieval section

104, 204, 304, 404, 504, 604 program information storage section

105, 205, 305, 405, 505, 605 remote controller receiving section

106, 206, 306, 406, 506, 606 video receiver control section

307, 407, 507, 607 video storage medium contorol section

308, 408, 508, 608 keyword obtainig section

409, 509, 609 program information change monitoring section

510, 610 area information storage section

611 channel information display section

### DETAILED DESCRIPTION OF THE INVENTION

Embodiments in accordance with the present invention will be described below referring to the accompanying drawings.

First Embodiment

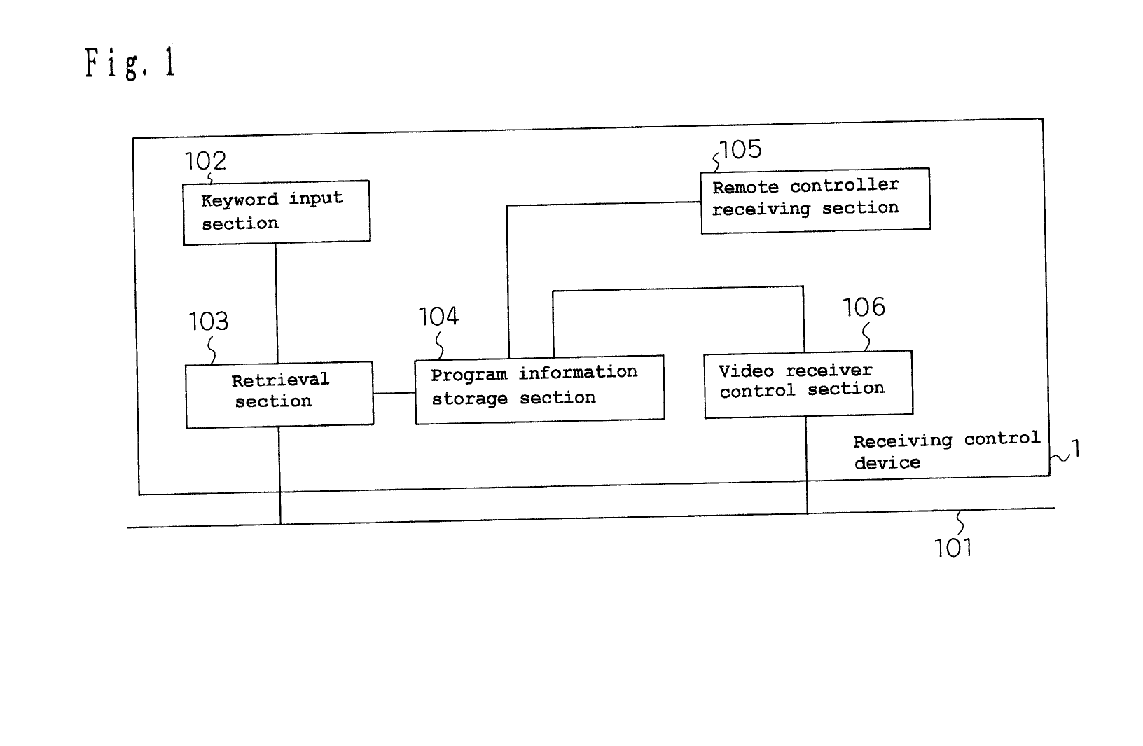

FIG. 1 is a block diagram showing the configuration of a receiving control device 1 in accordance with a first embodiment of the present invention.

Referring to FIG. 1, the receiving control device 1 of this embodiment comprises a keyword input section 102, a retrieval section 103 connected to a network 101 and used to retrieve program information by using keywords, a program information storage section 104 for storing retrieved program information, a remote controller receiving section 105 for recognizing the remote controller operation of the user, and a video receiver control section 106 for controlling a video receiver (not shown) connected to the network 101.

The network 101 is a network capable of data communications, device control, etc. This network may be attained by using a network specified in the IEEE1394 Standard, the Ethernet for carrying out communications based on TCP/IP or the like, for example.

The keyword input section 102 offers character information input means, such as a keyboard or a device similar thereto, to enable keyword information comprising plural characters to be input. For example, the keyword input section 102 enables a single keyword to be input, or creates a retrieval equation comprising plural keywords and logical equations or a retrieval equation based on SQL from a menu format based on GUI.

The retrieval section 103 inputs the keyword or retrieval equation input by the keyword input section 102 to a server on the network and receives the result of retrieval. For example, the retrieval section 103 may input the retrieval equation created by the keyword input section 102 on the basis of the HTTP protocol to an HTTP server having a retrieval function and storing program information on the network, and may obtain the result on the basis of the HTTP protocol. Furthermore, when the server allows access to a database, the result of the retrieval may be obtained by directly issuing an SQL statement to the database by using a communication protocol, such as TCP/IP. The result of the retrieval includes information regarding at least program title, date of broadcasting, start time, end time and broadcast channel number for one program.

The program information storage section 104 stores the result of the retrieval carried out by the retrieval section 103. Program information is controlled in accordance with a table comprising at least keyword information during retrieval, program title, date of broadcasting, start time, end time and broadcast channel number for one program. The channel number on which the program is broadcast can be obtained by using the keyword information and the current time.

The remote controller receiving section 105 receives signals from a remote controller and obtains the channel number selected by the user via the remote controller. Furthermore, the keyword registered in the keyword input section 102 is assigned to the channel number on the remote controller, and the channel number selected by the user via the remote controller is converted into keyword information.

The video receiver control section 106 controls video receivers on the network, such as tuners, by using control protocols, such as AV/C commands. The video receiver control section 106 can at least designate a receiving channel and start receiving video data.

The keyword input section 102 of this embodiment is an example of the keyword input means of the present invention. The retrieval section 103 of this embodiment is an example of the retrieval means of the present invention. The program information storage means 104 of this embodiment is an example of the user channel matching means of the present invention. The remote controller receiving section 105 of this embodiment is an example of the direction input means of the present invention. The program information storage section 104 and the video receiver control section 106 of this embodiment are examples of the control means of the present invention. The server of this embodiment is an example of the program information server of the present invention.

The operation of this embodiment will be described below.

First, the user registers a keyword characterizing a program he or she wishes to watch by using the keyword input section 102. When the keyword is registered, the retrieval section 103 retrieves program information in the server on the network and obtains program information.

For example, when the user wishes to watch a professional baseball game, the user should just input “baseball” or the like as a keyword. Furthermore, if the user is interested in a baseball game between Giants and Tigers in particular, the user should just input “baseball, Giants and Tigers” or the like.

Next, in accordance with the result of the retrieval, the program information storage section 104 establishes the relationship between the keyword and program data and creates a program table Next, the program information storage section 104 assigns one registered keyword to each channel of the remote controller that is operated by the user. For example, a keyword “baseball” is assigned to Channel 3 of the remote controller.

When the user selects a channel by operating the remote controller, the remote controller receiving section 105 obtains the keyword information assigned to the selected channel and inputs the keyword information to the program information storage section 104. The program information storage section 104 retrieves program information in the program table in accordance with the input keyword and the current time. If an applicable program being broadcast is present, the program information storage section 104 obtains a broadcast channel number and inputs the number to the video receiver control section 106. For example, when Channel 3 of the remote controller is selected, keyword information “baseball” is obtained by the remote controller receiving section 105 and input to the program information storage section 104. When the current time is 20:00 for example, and when a program relating to “baseball” and being broadcast at 20:00 is available, the program information storage section 104 obtains the broadcast channel number corresponding to the program and inputs the channel number to the video receiver control section 106.

The video receiver control section 106 issues a control command to a video receiver on the network and changes its channel for reception. Hence, when a program relating to “baseball” is available, the user can watch the program.

As described above, in accordance with this embodiment, the user can classify broadcast programs by using a keyword and can virtually create broadcast channels through which only the programs including the keyword designated by the user are broadcast apparently.

Assigning a keyword to each channel of the remote controller by the user can also be carried out as described below. That is, when watching a program being broadcast at present, the user selects a keyword assignment mode by operating the keys on the remote controller. When the user presses a channel number on the remote controller the user wishes to register, the keyword added to the program information relating to the program being broadcast at present is assigned to the channel number. The retrieval section 103 retrieves program information relating to this keyword. In this way, the user can save time and effort of inputting the keyword.

Second Embodiment

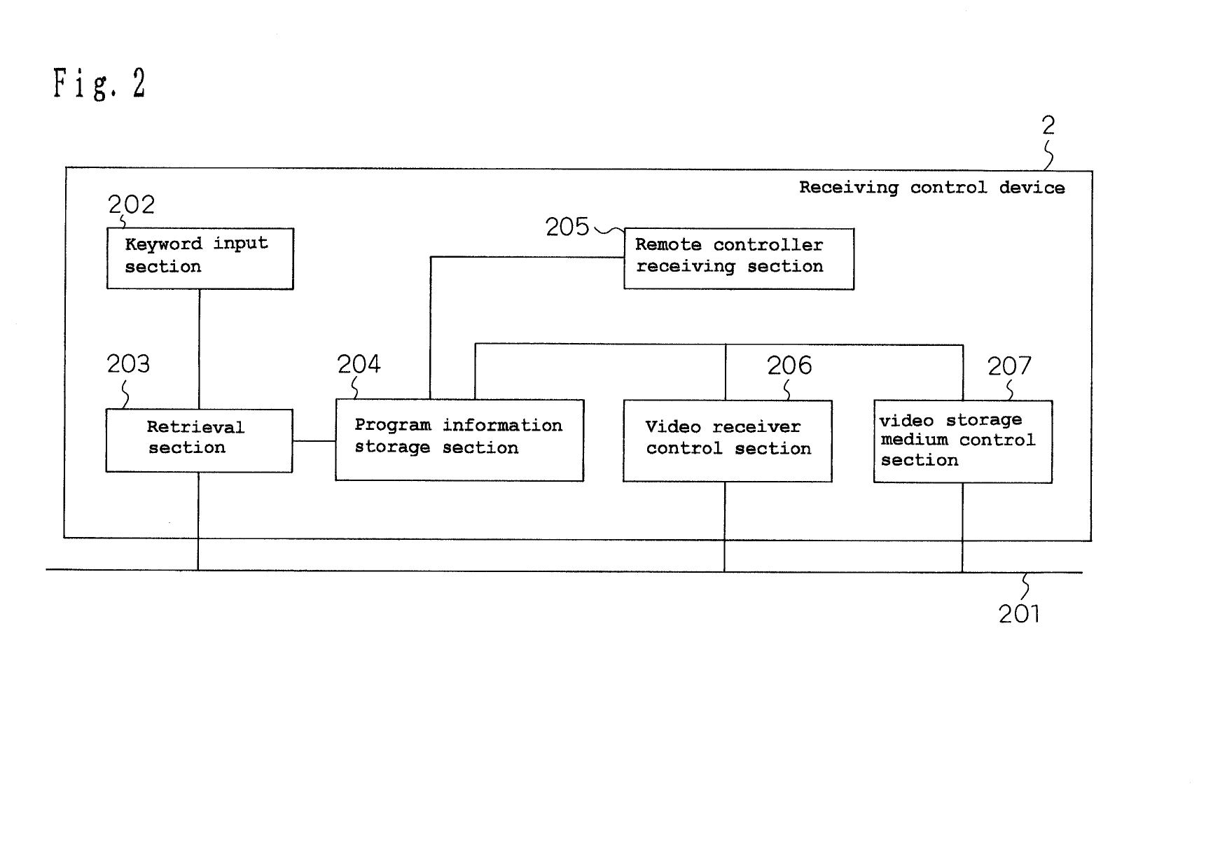

FIG. 2 is a block diagram showing the configuration of a receiving control device 2 in accordance with a second embodiment of the present invention. Referring to FIG. 2, a network 201, a keyword input section 202, a retrieval section 203, a program information storage section 204, a remote controller receiving section 205 and a video receiver control section 206 are the same as those described in the first embodiment; their explanations are thus omitted.

However, unlike the receiving control device in accordance with the first embodiment, the receiving control device 2 in accordance with the second embodiment is provided with a video storage medium control section 207 for controlling other video storage media connected to the network.

The keyword input section 202 of this embodiment is an example of the keyword input means of the present invention. The retrieval section 203 of this embodiment is an example of the retrieval means of the present invention. The program information storage means 204 of this embodiment is an example of the user channel matching means of the present invention. The remote controller receiving section 205 of this embodiment is an example of the direction input means of the present invention. The program information storage section 204 and the video receiver control section 206 of this embodiment are examples of the control means of the present invention. The program information storage section 204 and the video storage medium control section 207 of this embodiment are examples of the video recording medium control means of the present invention. The server of this embodiment is an example of the program information server of the present invention.

The operation of this embodiment will be described below.

Controlled by the program information storage section 204, the video storage medium control section 207 issues control commands for recording the program on a designated broadcast channel on a designated video storage medium at a designated time to a video storage medium on the network. AV/C commands or the like may be used as control commands. In addition, the video storage medium control section 207 issues control commands for reproducing and transmitting the recorded program to a designated video receiver at a time designated by the program information storage section 204.

When programs characterized by the same keyword are being broadcast on plural channels at the same time period, the program information storage section 204 records programs other than either one of the programs via the video storage medium control section 207.

When the user operates the remote controller and when there is only one program that is characterized by the keyword assigned to the channel selected by the user through the remote controller, the video receiver control section 206 controls the video receiver so as to receive the program, and the program is displayed.

On the other hand, when there are plural programs that are characterized by the keyword assigned to the channel selected by the user through the remote controller, a program being broadcast on either one of channels is displayed. The programs on the other channels are recorded on a recording medium via the video storage medium control section 207.

Furthermore, when there are no programs that are characterized by the keyword assigned to the channel selected by the user through the remote controller, a program characterized by the keyword is retrieved from among programs recorded on a video storage medium and then displayed.

As described above, in accordance with this embodiment, even when there are plural programs that are characterized by the same keyword at the same time period, the user can store the programs temporarily, whereby it is possible to increase time during which the user can watch programs on virtual broadcast channels.

Third Embodiment

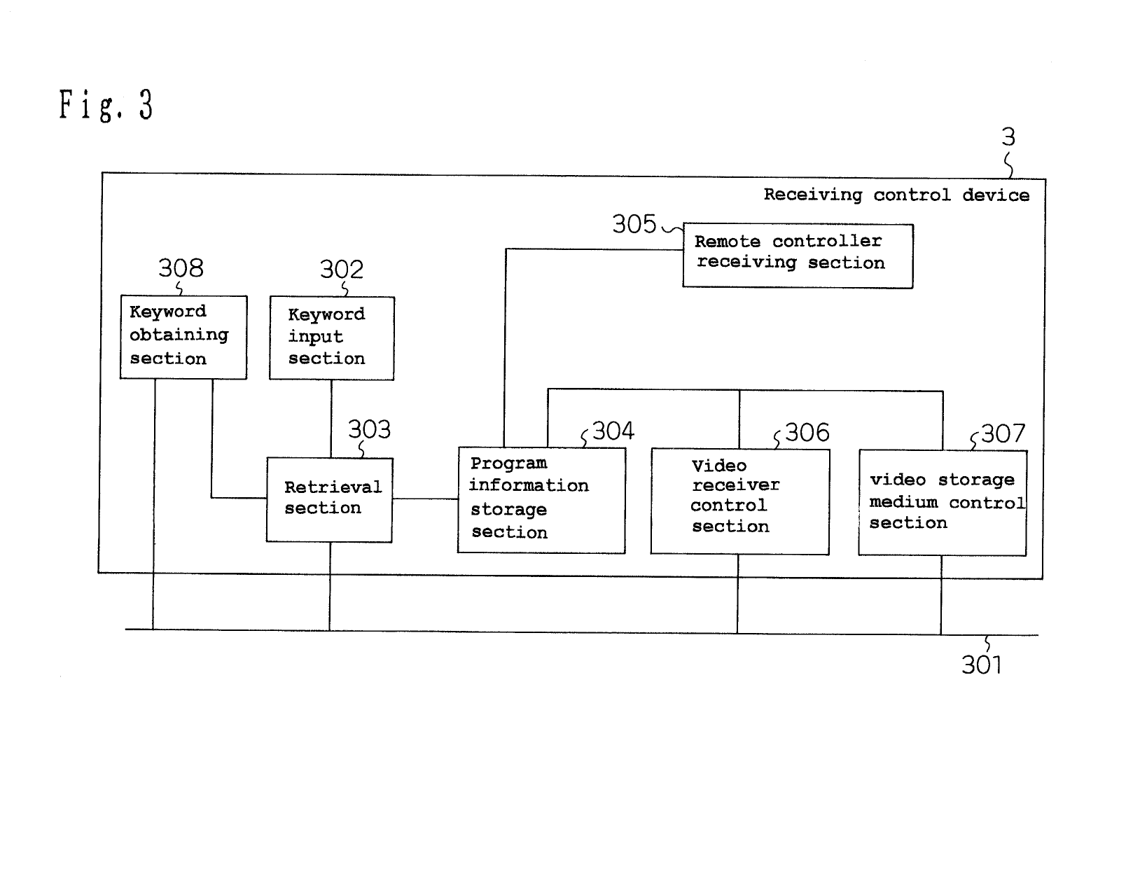

FIG. 3 is a block diagram showing the configuration of a receiving control device 3 in accordance with a third embodiment of the present invention. Referring to FIG. 3, a network 301, a keyword input section 302, a retrieval section 303, a program information storage section 304, a remote controller receiving section 305, a video receiver control section 306 and a video storage medium control section 307 are the same as those described in the second embodiment; their explanations are thus omitted.

However, unlike the receiving control device in accordance with the second embodiment, the receiving control device 3 in accordance with the third embodiment is provided with a keyword obtaining section 308 for obtaining a table of keyword information from the server on the network.

The keyword input section 302 and the keyword obtaining section 308 of this embodiment are examples of the keyword input means of the present invention. The retrieval section 303 of this embodiment is an example of the retrieval means of the present invention. The program information storage means 304 of this embodiment is an example of the user channel matching means of the present invention. The remote controller receiving section 305 of this embodiment is an example of the direction input means of the present invention. The program information storage section 304 and the video receiver control section 306 of this embodiment are examples of the control means of the present invention. The program information storage section 304 and the video storage medium control section 307 of this embodiment are examples of the video recording medium control means of the present invention. The server of this embodiment is an example of the program information server of the present invention, and is also used as an example of the keyword server of the present invention.

The operation of this embodiment will be described below.

The keyword obtaining section 308 obtains a table of keyword information from the server installed on the network by a broadcast station and shows the table to the user. When the amount of keyword information is large, the table may be shown to the user in a classification tree structure, such as a directory tree, by using an appropriate classification method. The keyword information is displayed graphically. When the user selects the keyword information, a retrieval condition used by the retrieval section 303 is created.

As described above, in accordance with this embodiment, by using keyword information recommended by the broadcast station, it is possible to increase time during which the user can watch programs on virtual broadcast channels. Furthermore, it is possible to decrease time required for the user to create virtual broadcast channels.

Fourth Embodiment

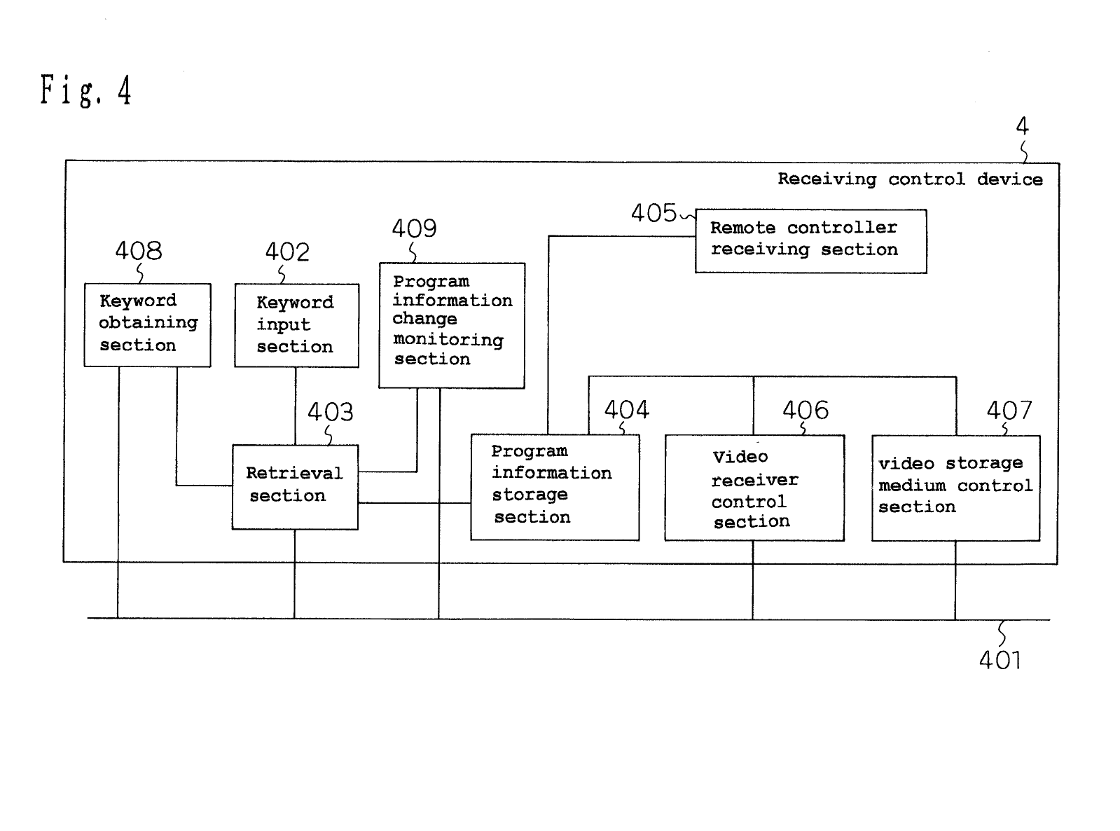

FIG. 4 is a block diagram showing the configuration of a receiving control device 4 in accordance with a fourth embodiment of the present invention. Referring to FIG. 4, a network 401, a keyword input section 402, a retrieval section 403, a program information storage section 404, a remote controller receiving section 405, a video receiver control section 406, a video storage medium control section 407 and a keyword obtaining section 408 are the same as those described in the third embodiment; their explanations are thus omitted.

However, unlike the receiving control device in accordance with the third embodiment, the receiving control device 4 in accordance with the fourth embodiment is provided with a program information change monitoring section 409 for monitoring changes in program information.

The keyword input section 402 and the keyword obtaining section 408 of this embodiment are examples of the keyword input means of the present invention. The retrieval section 403 of this embodiment is an example of the retrieval means of the present invention. The program information storage means 404 of this embodiment is an example of the user channel matching means of the present invention. The remote controller receiving section 405 of this embodiment is an example of the direction input means of the present invention. The program information storage section 404 and the video receiver control section 406 of this embodiment are examples of the control means of the present invention. The program information storage section 404 and the video storage medium control section 407 of this embodiment are examples of the video recording medium control means of the present invention. The program information change monitoring section 409 of this embodiment is an example of the program information monitoring means of the present invention. The server of this embodiment is an example of the program information server of the present invention, and is also used as an example of the keyword server of the present invention.

The operation of this embodiment will be described below.

The program information change monitoring section 409 stores the identification code of the server on which retrieval is carried out by the retrieval section 403 and also stores time information at the time when the retrieval is carried out, and then makes inquiries to the server at constant time intervals as to whether program information is renewed or not. The judgment as to whether program information is renewed or not is determined according to the time stamp for the data in an obtained program table for example.

When a renewal of the program table is detected, the program information change monitoring section 409 directs the retrieval section 403 to carry out program retrieval again.

As described above, this embodiment can respond unexpected program changes, whereby it is possible to improve the reliability of the contents of virtual broadcast channels.

Fifth Embodiment

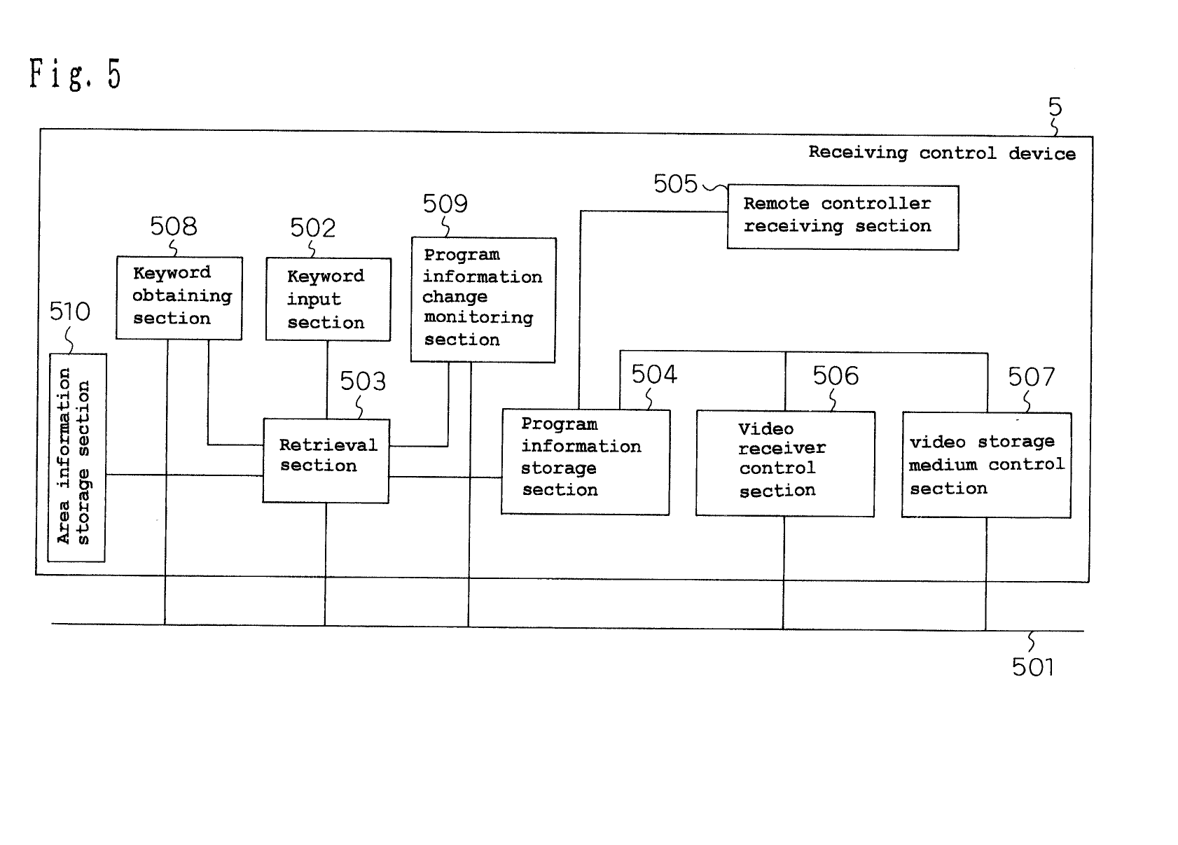

FIG. 5 is a block diagram showing the configuration of a receiving control device 5 in accordance with a fifth embodiment of the present invention. Referring to FIG. 5, a network 501, a keyword input section 502, a retrieval section 503, a program information storage section 504, a remote controller receiving section 505, a video receiver control section 506, a video storage medium control section 507, a keyword obtaining section 508 and a program information change monitoring section 509 are the same as those described in the fourth embodiment; their explanations are thus omitted.

However, unlike the receiving control device in accordance with the fourth embodiment, the receiving control device 5 in accordance with the fifth embodiment is provided with an area information storage section 510 for storing information on the area in which the receiving control device 5 is installed.

The keyword input section 502 and the keyword obtaining section 508 of this embodiment are examples of the keyword input means of the present invention. The retrieval section 503 of this embodiment is an example of the retrieval means of the present invention. The program information storage means 504 of this embodiment is an example of the user channel matching means of the present invention. The remote controller receiving section 505 of this embodiment is an example of the direction input means of the present invention. The program information storage section 504 and the video receiver control section 506 of this embodiment are examples of the control means of the present invention. The program information storage section 504 and the video storage medium control section 507 of this embodiment are examples of the video recording medium control means of the present invention. The program information change monitoring section 509 of this embodiment is an example of program information monitoring means of the present invention. The area information storage section 510 of this embodiment is an example of the area information holding means of the present invention. The server of this embodiment is an example of the program information server of the present invention, and is also used as an example of the keyword server of the present invention.

The operation of this embodiment will be described below.

The area information storage section 510 stores area information represented by an area code or the like at an installation location. When carrying out program retrieval, the retrieval section 503 obtains area information from the area information storage section 510, adds a keyword to the area information and carries out program retrieval.

As described above, in this embodiment, area information is added, and program retrieval is carried out. Hence, audience measurement in each area and local programs in the area can also be included as retrieval targets. It is thus possible to increase time during which the user can watch programs on virtual broadcast channels.

In this embodiment, it is explained that the area code of the installation location is used as area information. However, this embodiment is not limited to this. The area information should only be information capable of uniquely specifying an area, such as a character and/or numeral assigned to each area so as to specify the area.

Sixth Embodiment

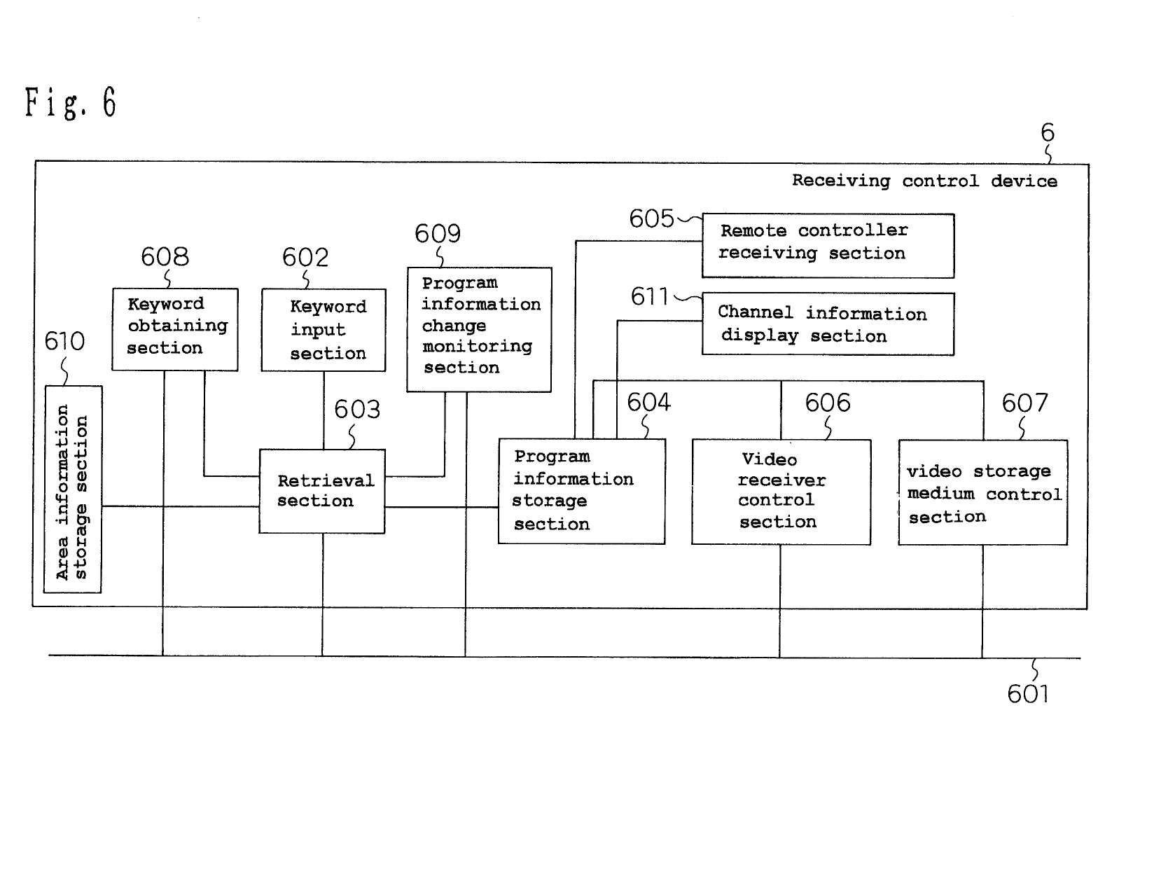

FIG. 6 is a block diagram showing the configuration of a receiving control device 6 in accordance with a sixth embodiment of the present invention. Referring to FIG. 6, a network 601, a keyword input section 602, a retrieval section 603, a program information storage section 604, a remote controller receiving section 605, a video receiver control section 606, a video storage medium control section 607, a keyword obtaining section 608, a program information change monitoring section 609 and an area information storage section 610 are the same as those described in the fifth embodiment; their explanations are thus omitted.

However, unlike the receiving control device in accordance with the fifth embodiment, the receiving control device 6 in accordance with the sixth embodiment is provided with a channel information display section 611 for displaying program information stored in the program information storage section 604 to the user.

The keyword input section 602 and the keyword obtaining section 608 of this embodiment are examples of the keyword input means of the present invention. The retrieval section 603 of this embodiment is an example of the retrieval means of the present invention. The program information storage means 604 of this embodiment is an example of the user channel matching means of the present invention. The remote controller receiving section 605 of this embodiment is an example of the direction input means of the present invention. The program information storage section 604 and the video receiver control section 606 of this embodiment are examples of the control means of the present invention. The program information storage section 604 and the video storage medium control section 607 of this embodiment are examples of the video recording medium control means of the present invention. The program information change monitoring section 609 of this embodiment is an example of program information monitoring means of the present invention. The area information storage section 610 of this embodiment is an example of the area information holding means of the present invention. The channel information display section 611 of this embodiment is an example of the program information display means of the present invention. The server of this embodiment is an example of the program information server of the present invention, and is also used as an example of the keyword server of the present invention.

The operation of this embodiment will be described below.

The channel information display section 611 is a bitmap display capable of carrying out at least GUI display. The channel information display section 611 indicates table-format program information comprising at least keyword information, time information and program titles.

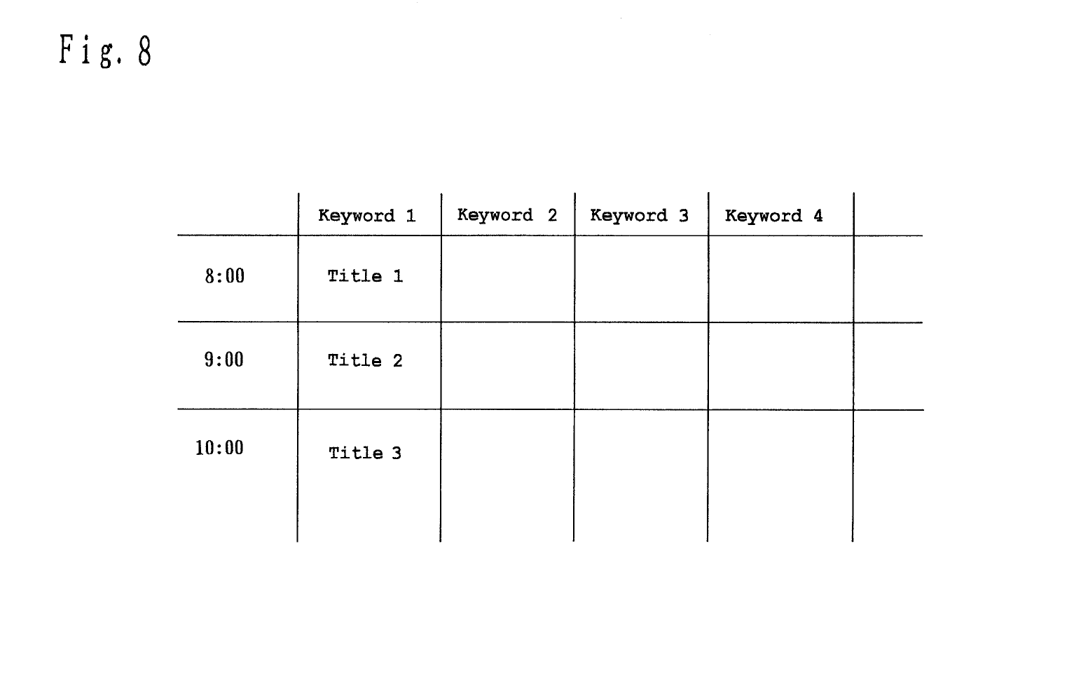

FIG. 8 is an example of program information displayed by the channel information display section 611. In this example, the abscissa represents keyword information and the ordinate represents time information. Program titles specified by keywords and time information are indicated in the table. The user can select a desired program from this table by operating the cursor keys on the remote controller, whereby virtual broadcast stations characterized by keywords can be offered to the user.

As described above, in accordance with this embodiment, a graphically indicated program table is shown to the user. Hence, virtual channels can be shown in the same format as used for conventional broadcast stations, whereby virtual channels can be offered to the user as broadcast stations characterized by keywords, and personal broadcasting service for individual users can be carried out.

In this embodiment, it is explained that the receiving control device obtains program information retrieved from the server connected to the network. However, this embodiment is not limited to this. The retrieval section of the receiving control device may hold program information to be retrieved, and from this program information, the retrieval section itself may retrieve and obtain program information of programs relating to keywords.

The direction input means of the present invention is not limited to the remote controller receiving section in accordance with this embodiment, but in short it should only be means of inputting directions, such as means of inputting directions from an operation panel provided on the receiving control device.

In this embodiment, it is explained that the keyword obtaining section obtains plural keywords from the server. However, this embodiment is not limited to this. The keyword obtaining section itself may hold plural keywords and may select a keyword to be used for retrieval from the plural keywords.

Furthermore, the program information server of the present invention may also have the function of the keyword server of the present invention.

Furthermore, the program information server of the present invention may comprise a single server, and the single server may store program information. Alternatively, the program information server may comprise plural servers, and each of the plural servers may store program information in a distributed manner.

Furthermore, in this embodiment, it is explained that keywords are registered by using the keyword input section and that when the keywords are registered the retrieval section retrieves and obtains program information in the server on the network. However, this embodiment is not limited to this. When keywords are registered by using the keyword input section, the keywords are first assigned to the channels of the remote controller to be operated by the user. When the user selects a channel of the remote controller, the retrieval section may retrieve program information according to the keyword assigned beforehand to the selected channel. With this configuration, the display of a program being broadcast at present can be controlled at all times according to the newest program information by simply selecting a channel of the remote controller, although the period from the time when the user selects the channel of the remote controller to the time when the program being broadcast at present is displayed may become longer slightly.

The medium of the present invention is a medium holding programs and/or data for activating all or part of functions of all or part of means of the receiving control device of the present invention on a computer. Media capable of being processed by a computer are also included in the present invention.

Furthermore, an information aggregate characterized by programs and/or data for activating all or part of functions of all or part of means of the receiving control device of the present invention on a computer is also included in the present invention.

Furthermore, the data of the present invention includes data structures, data formats, data types, etc. In addition, the medium of the present invention includes recording media, such as ROM; transmission media, such as the Internet; and transmission media, such as light, electric waves and sound waves. Furthermore, the medium holding data in accordance with the present invention includes recording media with recorded programs and/or data, transmission media for transmitting programs and/or data, etc. Furthermore, the expression “capable of being processed by a computer” means that programs and/or data can be read by a computer in the case when the medium is a recording medium, such as ROM. In the case when the medium is a transmission medium, the expression means that programs and/or data to be transmitted can be treated by the computer as the result of transmission. Still further, the information aggregate of the present invention includes software, such as programs and/or data.

Furthermore, the program recording medium with recorded programs and/or data for activating all or part of functions of all or part of means of the receiving control device described in any one of the above-mentioned embodiments on a computer may be a program recording medium that can be read by a computer, wherein the programs and/or data having been read by the computer execute the above-mentioned functions in cooperation with the computers.

As clarified as described above, the present invention can provide a receiving control device, a medium and an information aggregate, capable of facilitating the finding of programs suited for the preferences of the user.

Furthermore, the present invention can provide a receiving control device, a medium and an information aggregate for enabling each user to watch programs suited for the preferences of the user as if broadcasting is carried out by using dedicated channels.

What is claimed is:

1. A receiving control device comprising:
keyword input means of inputting a keyword,
retrieval means of obtaining program information of a program relating to said input keyword,
user channel matching means of matching said obtained program information with a predetermined user channel number,
direction input means of receiving directions from a user, and
control means of controlling a video receiver,
Wherein
when a direction is received from said direction input means, said control means obtains the broadcast channel number of a program being broadcast at present on said predetermined user channel number and informs said video receiver of said broadcast channel number.

2. A receiving control device comprising:
keyword input means of inputting a keyword,
retrieval means of obtaining program information of a program relating to said input keyword,
user channel matching means of matching said keyword with a predetermined user channel number,
direction input means of receiving directions from a user, and
control means of controlling a video receiver,
Wherein
when a direction is received from said direction input means, said retrieval means obtains program information of a program relating to said keyword matched with said predetermined user channel number, and
said control means obtains the broadcast channel number of a program being broadcast at present from said obtained program information and informs said video receiver of said broadcast channel number.

3. A receiving control device in accordance with claim 1 or 2, wherein said obtained program information includes at least broadcast channel number, broadcast start time and broadcast end time.

4. A receiving control device in accordance with any one of claims 1 to 3, wherein said retrieval means retrieves program information to obtain a program relating to said keyword.

5. A receiving control device in accordance with any one of claims 1 to 3, wherein
said retrieval means transmits said keyword input via a network to a program information server connected to said network,
said program information server stores program information, and retrieves program information of a program relating to said keyword from said stored program information by using said transmitted keyword, and
said retrieval means obtains said program information retrieved by said program information server.

6. A receiving control device in accordance with claim 5, further comprising video recording medium control means of operating a recording medium for recording video information, wherein
when programs matched with said predetermined user channel number are broadcast on plural broadcast channels, said video recording medium control means records programs other than at least either one of the programs on said video recording medium, and
when a direction is received from said direction input means in a time period during which there is no program matched with said predetermined user channel number, said video recording medium control means reproduces said programs recorded on said video recording media.

7. A receiving control device in accordance with claim 5 or 6, wherein said keyword input means inputs said keywords from a keyword server connected to said network and used to transmit said keywords.

8. A receiving control device in accordance with claim 7, wherein
inputting said keywords means that plural keywords are obtained from said keyword server, and
said keywords to be input are those selected from among said plural keywords.

9. A receiving control device in accordance with any one of claims 5 to 8, further comprising program information change monitoring means for carrying out monitoring as to whether program information stored in said program information server is renewed or not, wherein
when said program information change monitoring means detects that the program information stored in said program information server is renewed after the time when said retrieval means last obtained program information of a program relating to said keyword,
said retrieval means renews said obtained program information on the basis of the result of said detection.

10. A receiving control device in accordance with claim 9, wherein said detection is carried out by making inquiries to said program information server at predetermined time intervals as to the renewal time of said program information stored in said program information server.

11. A receiving control device in accordance with any one of claims 5 to 10, further comprising an area information holding means of holding area information for specifying an area wherein said receiving control device itself is installed, wherein
when transmitting said input keywords to said program information server, said retrieval means also transmits said area information to said program information server, and
said program information server carries out retrieval in consideration of said transmitted area information.

12. A receiving control device in accordance with any one of claims 1 to 11, further comprising a program information display means of displaying program information, wherein
said program information display means displays said program information in a table format including at least said keywords or said remote controller channel numbers corresponding to said keywords, time information, program titles,
one of the ordinate and the abscissa of said format represents said keywords or said remote controller channel numbers corresponding to said keywords, and the other represents time information.

13. A receiving control device in accordance with claim 7 or 8, wherein said program information server has the function of said keyword server.

14. A medium having programs and/or data for activating all or part of functions of all or part of means of said receiving control device in accordance with any one of claims 1 to 13 on a computer, wherein said medium can be processed by a computer.

15. An information aggregate characterized by programs and/or data for activating all or part of functions of all or part of means of said receiving control device in accordance with any one of claims 1 to 13 on a computer.
